(19) United States
(12) Patent Application Publication
(10) Pub. No.: US 2014/0152586 A1
(43) Pub. Date: Jun. 5, 2014

(54) ELECTRONIC APPARATUS, DISPLAY CONTROL METHOD AND STORAGE MEDIUM

(71) Applicant: KABUSHIKI KAISHA TOSHIBA, Tokyo (JP)

(72) Inventor: Yoshikazu TERUNUMA, Ome-shi (JP)

(73) Assignee: KABUSHIKI KAISHA TOSHIBA, Tokyo (JP)

(21) Appl. No.: 13/769,009

(22) Filed: Feb. 15, 2013

(30) Foreign Application Priority Data
Nov. 30, 2012 (JP) 2012-262081

(51) Int. Cl. G06F 3/048

(52) U.S. Cl. CPC G06F 3/048
USPC 345/173

(57) ABSTRACT

According to one embodiment, an electronic apparatus includes an acquirer and a display controller. The acquirer is configured to acquire a contact area on a touchscreen display. The display controller is configured to execute display control of a first object if the contact area acquired by the acquirer is less than a first value. The display controller is further configured to execute display control of a second object different from the first object if the contact area acquired by the acquirer is not less than the first value.

### CROSS-REFERENCE TO RELATED APPLICATIONS

This application is based upon and claims the benefit of priority from Japanese Patent Application No. 2012-262081, filed Nov. 30, 2012, the entire contents of which are incorporated herein by reference.

### FIELD

Embodiments described herein relate generally to a display control technique of an electronic apparatus including a gesture interaction function.

### BACKGROUND

In recent years, portable electronic apparatuses such as tablet computers and smartphones, which can be powered by batteries, have prevailed. Most electronic apparatuses of this type include touchscreen displays to facilitate user interaction.

The user touches an object such as an icon or menu displayed on the touchscreen display with the finger to instruct the electronic apparatus to execute a function associated with the icon or menu.

As for user interaction (gestures) via this touchscreen display, various proposals have been made so far.

Thicknesses of fingers have personal differences. Even the fingers of a particular person, for example, the thumb and index finger, have different thicknesses. Furthermore, even with the same finger of a particular person, the contact area on the touchscreen display varies depending on the ways the display is touched.

However, conventionally, contact areas at the time of detecting gestures are not taken into account when displaying objects such as icons and menus on the touchscreen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an electronic apparatus according to an embodiment.

FIG. 2 is an exemplary block diagram showing the system arrangement of the electronic apparatus according to the embodiment.

FIG. 3 is an exemplary functional block diagram of a digital notebook application program, which runs on the electronic apparatus according to the embodiment.

FIG. 4 is an exemplary first view for explaining the operation principle of the digital notebook application (object display control module), which runs on the electronic apparatus according to the embodiment.

FIG. 5 is an exemplary second view for explaining the operation principle of the digital notebook application (object display control module), which runs on the electronic apparatus according to the embodiment.

FIG. 6 is an exemplary flowchart showing the processing sequence of menu display control executed by the electronic apparatus according to the embodiment.

### DETAILED DESCRIPTION

Various embodiments will be described hereinafter with reference to the accompanying drawings.

In general, according to one embodiment, an electronic apparatus includes an acquirer and a display controller. The acquirer is configured to acquire a contact area on a touchscreen display. The display controller is configured to execute display control of a first object if the contact area acquired by the acquirer is less than a first value. The display controller is further configured to execute display control of a second object different from the first object if the contact area acquired by the acquirer is not less than the first value.

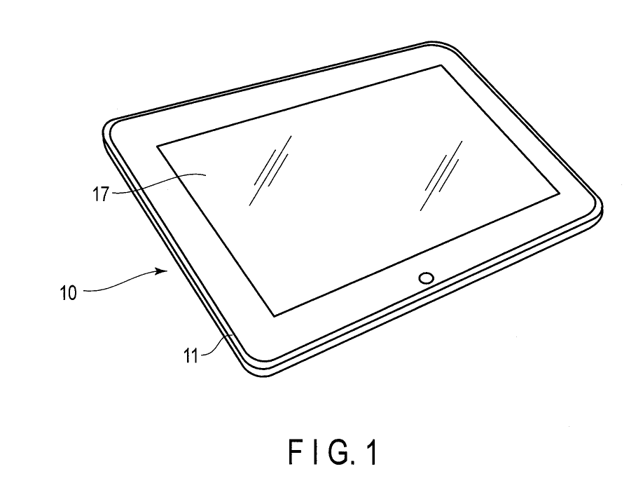

An electronic apparatus of this embodiment can be implemented as, for example, a portable electronic apparatus such as a tablet computer, notebook computer, or smartphone, which allows the user to make gestures with a finger. FIG. 1 is an exemplary perspective view showing the outer appearance of the electronic apparatus according to this embodiment. Assume that the electronic apparatus of this embodiment is implemented as a tablet computer 10, as shown in FIG. 1. The tablet computer 10 includes a main body 11 and touchscreen display 17. The touchscreen display 17 is attached to be overlaid on the upper surface of the main body 11.

The main body 11 has a low profile, box shaped housing. In the touchscreen display 17, a flat panel display and a sensor configured to detect a contact position of the finger on the screen of the flat panel display are incorporated. The flat panel display is, for example, a liquid crystal display (LCD). The sensor is, for example, a capacitive touchpanel. The touchpanel is arranged to cover the screen of the flat panel display.

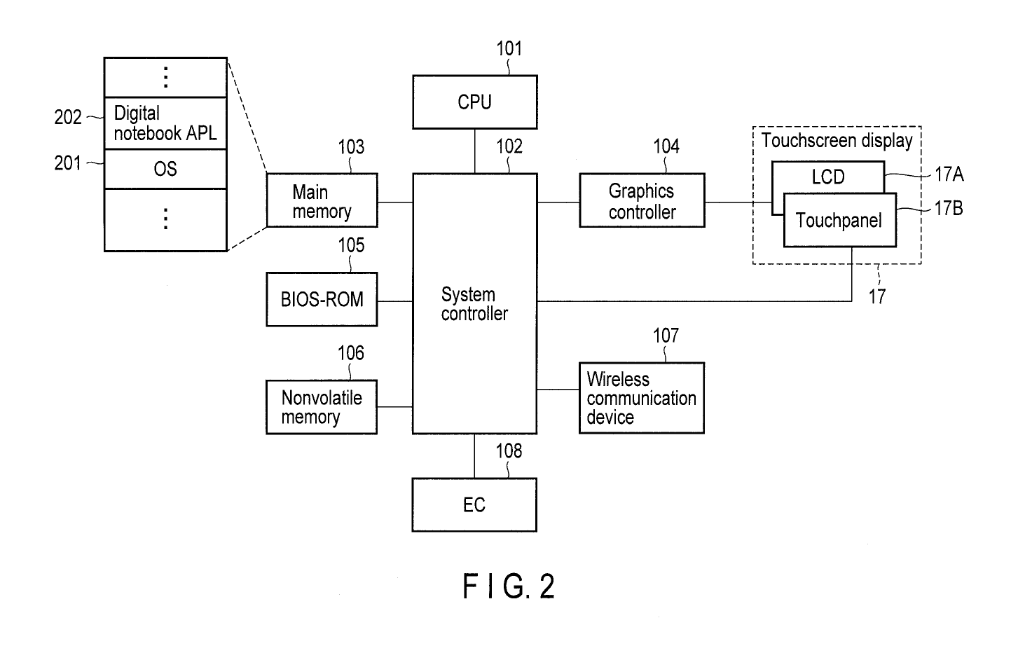

FIG. 2 is an exemplary block diagram showing the system arrangement of the tablet computer 10.

As shown in FIG. 2, the tablet computer 10 includes a CPU 101, system controller 102, main memory 103, graphics controller 104, BIOS-ROM 105, nonvolatile memory 106, wireless communication device 107, embedded controller (EC) 108, and the like.

The CPU 101 is a processor, which controls the operations of various modules in the tablet computer 10. The CPU 101 executes various software programs loaded from the nonvolatile memory 106 onto the main memory 103. These software programs include an operating system (OS) 201 and various applications, including a digital notebook application 202. The digital notebook application 202 is a program required to provide a user interface which allows the user to input an instruction to the tablet computer 10, and includes a function of displaying objects such as icons and menus on the touchscreen display. In this tablet computer 10, the digital notebook application 202 incorporates a mechanism for executing appropriate display control of objects based on the contact area when a gesture is made, and this mechanism will be described later.

The CPU 101 also executes a BIOS (Basic Input/Output System) stored in the BIOS-ROM 105. The BIOS is a program required for hardware control.

The system controller 102 is a device which connects between a local bus of the CPU 101 and various components. The system controller 102 incorporates a memory controller which controls accesses to the main memory 103. Also, the system controller 102 includes a function of executing communications with the graphics controller 104 via, for example, a PCI EXPRESS serial bus.

The graphics controller 104 is a display controller which controls an LCD 17A used as a display monitor of the tablet computer 10. A display signal generated by this graphics controller 104 is supplied to the LCD 17A. The LCD 17A displays a screen image based on the display signal. A touchpanel 17B is arranged on the LCD 17A. The touchpanel 17B is, for example, a capacitive pointing device required to make inputs on the screen of the LCD 17A. A contact position of the finger on the screen is detected by this touchpanel 17B.

The wireless communication device 107 is a device configured to execute wireless communications such as wireless LAN or 3G mobile communication. The EC 108 is a one-chip microcomputer including an embedded controller required for power management. The EC 108 includes a function of turning on/off a power supply of the tablet computer 10 in response to an operation of a power button by the user.

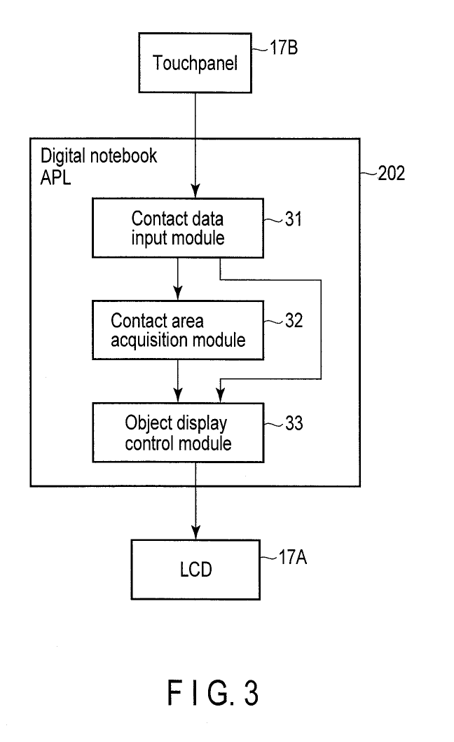

FIG. 3 is an exemplary functional block diagram of the digital notebook application 202, which runs on the tablet computer 10.

As shown in FIG. 3, the digital notebook application 202 includes a contact data input module 31, contact area acquisition module 32, object display control module 33, and the like.

As described above, the touchscreen display 17 detects a gesture on the screen using the touchpanel 17B. The contact data input module 31 is a module which inputs a detection signal output from the touchpanel 17B. The detection signal includes coordinate information (X, Y). The detection signal input by the contact data input module 31 is supplied to the contact area acquisition module 32 and object display control module 33.

The contact area acquisition module 32 is a module which acquires (calculates) a contact area of the finger on the screen based on the detection signal from the contact data input module 31. An acquisition method of the contact area is not particularly limited and may use existing methods as long as a contact area can be acquired. The contact area acquisition module 32 supplies contact area data indicating the acquired contact area to the object display control module 33.

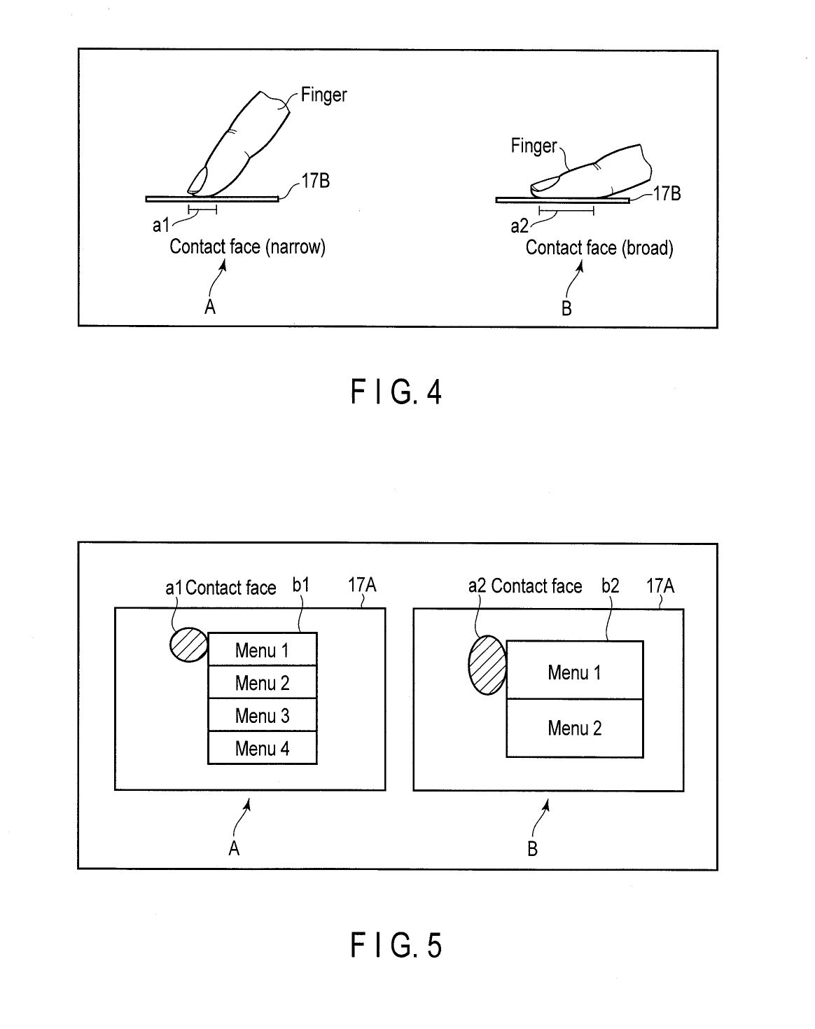

The object display control module 33 is a module which displays objects such as icons and menus on the LCD 17A based on the detection signal from the contact data input module 31 and the contact area data from the contact area acquisition module 32. The object display control module 33 includes a function of controlling, for example, display sizes of objects such as icons and menus based on the contact area data from the contact area acquisition module 32. The operation principle of this object display control module 33 will be described below with reference to FIG. 4 and FIG. 5.

Now assume that a popup menu is ready to be displayed at an arbitrary position when the user touches that position on the touchpanel 17B as if the popup menu were displayed at a position pointed by a pointer by clicking the right button of a mouse (right clicking). In order words, assume that a screen which can accept a display request of the popup menu is currently displayed.

Also, for example, assume that a certain user makes a gesture required to display the popup menu using the tip of a finger and, as a result, contacts a relatively restricted region (contact face a1) of the touchpanel 17B with the finger, as indicated by “A” in FIG. 4. Furthermore, assume that another user makes the same gesture with the flat of the finger and, as a result, contacts a relatively broad region (contact face a2) of the touchpanel 17B with the finger, as indicated by “B” in FIG. 4.

The object display control module 33 determines, for example, whether or not the contact area indicated by the contact area data received from the contact area acquisition module 32 is greater than or equal to a threshold, upon displaying the popup menu on the LCD 17A in response to this gesture. When the contact area is less than the threshold, the object display control module 33 displays the popup menu normal size (b1), as indicated by “A” in FIG. 5. In contrast, when the contact area is greater than or equal to the threshold, the object display control module 33 displays the popup menu enlarged (b2), as indicated by “B” in FIG. 5. This enlarged display of the popup menu may be attained by displaying text data included in the menu using a font size larger than the normal size or by enlarging and displaying image data for the menu. In place of enlarging the image data for the menu in each case, image data for enlarged display may be prepared, and may be displayed in place of normal-size image data.

Under this display control of the object display control module 33, the display font and size of the menu can be changed according to the thickness of the fingers of different people, the actual finger to be used, and the way of making the gesture. For example, a user with thick fingers can be prevented from having difficulty with an operation for fine menu items. Conversely, for example, large menu items more than necessary (to decrease the number of choices presented) can be prevented from being displayed for a user with thin fingers.

The user may selectively use the fingers used to make a gesture. For example, the thumb may be used when making a gesture while holding the tablet computer 10 in the hand, and the index finger used when making a gesture on the tablet computer 10 placed on a desk. In such a case, under the display control of the object display control module 33, the popup menu is displayed enlarged in the former case and normal size in the latter case. That is, menu display suited to a use scenario is possible.

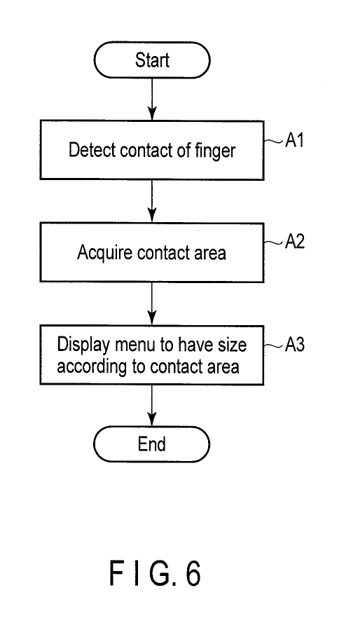

FIG. 6 is an exemplary flowchart showing the processing sequence of the menu display control executed by the tablet computer 10.

When the user makes a gesture on the touchscreen display 17, the touchpanel 17B detects contact of the finger on the touchscreen display 17 (block A1). The digital notebook application 202 instructs the data input module 31 to input a detection signal output from the touchpanel 17B, and instructs the contact area acquisition module 32 to acquire a contact area of the finger (block A2). The digital notebook application 202 instructs the object display control module 33 to display a menu on the LCD 17A to have a size according to the contact area (block A3).

In the above description, the display control of the menu in two levels (whether the menu is displayed normal size or enlarged) has been exemplified. Alternatively, the display size of the menu can be controlled in three levels or more by setting a plurality of thresholds to be compared with the contact area of the finger.

In place of controlling whether or not to display the menu enlarged, a menu itself can be variably displayed based on the contact area of the finger. For example, menu 1 may be displayed by a gesture with the tip of a finger, as indicated by “A” in FIG. 4, and menu 2 may be displayed by a gesture with the flat of the finger, as indicated by “B” in FIG. 4.

In the above description, the popup menu to be displayed at an arbitrary position by a gesture at that position has been exemplified. In place of the popup menu, for example, the display size of a pull down menu, which is displayed below an already displayed menu item by a gesture on that menu item, can be controlled based on the contact area of the finger. In the case of the pull down menu, for example, menu items are displayed side by side on an upper portion of the screen. Depending on the gesture situation on this menu item, whether or not the contact area of the finger is greater than or equal to the threshold may be simply determined (without actually calculating an area).

More specifically, for example, when a certain menu item is included in a contact region, it can be estimated that the contact area of the finger is less than the threshold. Conversely, when a contact region includes a certain menu item and extends over another menu item displayed beside the former item, it can be estimated that the contact area of the finger is greater than or equal to the threshold.

Furthermore, an object, the display size of which is controlled based on the contact area of the finger, is not limited to the menu, and this embodiment is also applicable to various other objects such as icons. For example, assume that when the user makes a gesture on a text box displayed on the screen as an input area, a virtual keyboard used to input characters in that text box is displayed. At this time, when the contact area is less than the threshold, for example, a virtual keyboard which imitates a keyboard of a personal computer (the number of keys is large, but each key is small) can be displayed.

Conversely, when the contact area is greater than or equal to the threshold, for example, a virtual keyboard which imitates operation buttons of a mobile phone (the number of keys is small, but each key is large) can be displayed. In this case, the user can actively selectively use two different virtual keyboards depending on whether he or she makes a gesture with the tip of the finger, as indicated by “A” in FIG. 4, or the flat of the finger, as indicated by “B” in FIG. 4.

As described above, according to the tablet computer 10 of this embodiment, appropriate display control of objects can be implemented based on the contact area at the time of a gesture.

Note that the operation sequence of this embodiment can be fully implemented by software. Hence, by installing this software in a normal computer via a computer readable storage medium, the same effects as in this embodiment can be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
an acquirer configured to acquire a contact area on a touchscreen display; and
a display controller configured to execute display control of a first object if the contact area acquired by the acquirer is less than a first value, and to execute display control of a second object different from the first object if the contact area acquired by the acquirer is not less than the first value.

2. The apparatus of claim 1, wherein the display controller is configured to display the first object with a first size if the contact area acquired by the acquirer is less than the first value, and to display the second object with a second size larger than the first size if the contact area acquired by the acquirer is not less than the first value.

3. The apparatus of claim 2, wherein:
the first object and the second object comprise a menu comprising text data; and
the display controller is configured to display the menu with a first font size if the contact area acquired by the acquirer is less than the first value, and to display the menu with a second font size larger than the first font size if the contact area acquired by the acquirer is not less than the first value.

4. The apparatus of claim 3, wherein the acquirer is configured to determine that an area of a target region is less than the first value if the target region of the gesture comprises only a display region of a third object on the touchscreen display, and to determine that the area of the target region is not less than the first value if the target region comprises the display region of the third object and extends over a display region of a fourth object on the touchscreen display beside the third object.

5. The apparatus of claim 2, wherein the acquirer is configured to determine that an area of a target region is less than the first value if the target region of the gesture comprises only a display region of a third object on the touchscreen display, and to determine that the area of the target region is not less than the first value if the target region comprises the display region of the third object and extends over a display region of a fourth object on the touchscreen display beside the third object.

6. The apparatus of claim 1, wherein the display controller is configured to display the first object if the contact area acquired by the acquirer is less than the first value, and to display the second object if the contact area acquired by the acquirer is not less than the first value.

7. The apparatus of claim 6, wherein the acquirer is configured to determine that an area of a target region is less than the first value if the target region of the gesture comprises only a display region of a third object on the touchscreen display, and to determine that the area of the target region is not less than the first value if the target region comprises the display region of the third object and extends over a display region of a fourth object on the touchscreen display beside the third object.

8. A display control method of an electronic apparatus with a touchscreen display, the method comprising:
acquiring a contact area on the touchscreen display;
executing display control of a first object if the acquired contact area is less than a first value; and
executing display control of a second object different from the first object if the acquired contact area is not less than the first value.

9. A computer-readable, non-transitory storage medium having stored thereon a computer program which is executable by a computer, the computer program controlling the computer to function as:
an acquirer configured to acquire a contact area on a touchscreen display; and
a display controller configured to execute display control of a first object if the contact area acquired by the acquirer is less than a first value, and to execute display control of a second object different from the first object if the contact area acquired by the acquirer is not less than the first value.
